(19) United States
(12) Patent Application Publication
(10) Pub. No.: US 2006/0265677 A1
(43) Pub. Date: Nov. 23, 2006

(54) Method and system for increased accuracy for extraction of electrical parameters

(75) Inventors: Louis K. Scheffer, Campbell, CA (US); Wolfgang H. Staud, Redwood City, CA (US); Judy Huckabay, Fremont, CA (US)

Correspondence Address: CADENCE DESIGN SYSTEMS, INC.;c/o BINGHAM MCCUTCHEN LLP, THREE EMBARCADERO CENTER, SAN FRANCISCO, CA, 94111-4067, US

(73) Assignee: Cadence Design Systems, Inc.

(21) Appl. No.: 11/437,794

(22) Filed: May 19, 2006

Related U.S. Application Data
(60) Provisional application No. 60/683,545, filed on May 20, 2005.

(51) Int. Cl. G06F 17/50

(52) U.S. Cl. 716/5

(57) ABSTRACT

An improved method, system, and computer program product is disclosed for increased accuracy for extraction of electrical parameters of an IC design. Extraction is performed upon the expected geometric model of the printed layout once manufacturing and lithographic process effects are taken into consideration. This provides a much more accurate approach for performing extraction since it is the actual expected geometric shapes that are analyzed, rather than an idealized model of the layout that does not accurately correspond to the actual manufactured IC product. The extracted electrical parameters are checked for acceptability. If not acceptable, then the IC design can be modified to address any identified problems or desired improvements to the design.

### RELATED APPLICATION

The present application claims the benefit of U.S. Provisional Application No. 60/683,545, filed May 20, 2005, the entire disclosure of which is hereby incorporated by reference herein.

### BACKGROUND AND SUMMARY

A semiconductor integrated circuit (IC) has a large number of electronic components, such as transistors, logic gates, diodes, wires, etc., that are fabricated by forming layers of different materials and of different geometric shapes on various regions of a silicon wafer. The design of an integrated circuit transforms a circuit description into a geometric description called a layout. The process of converting specifications of an integrated circuit into a layout is called the physical design. After the layout is complete, it is then checked to ensure that it meets the design requirements. The result is a set of design files, which are then converted into pattern generator files. The pattern generator files are used to produce patterns called masks by an optical or electron beam pattern generator. Subsequently, during fabrication of the IC, these masks are used to pattern chips on the silicon wafer using a sequence of photolithographic steps. Electronic components of the IC are therefore formed on the wafer in accordance with the patterns.

Many phases of physical design may be performed with computer aided design (CAD) tools or electronic design automation (EDA) systems. To design an integrated circuit, a designer first creates high level behavior descriptions of the IC device using a high-level hardware design language. An EDA system typically receives the high level behavior descriptions of the IC device and translates this high-level design language into netlists of various levels of abstraction using a computer synthesis process. A netlist describes interconnections of nodes and components on the chip and includes information of circuit primitives such as transistors and diodes, their sizes and interconnections, for example.

An integrated circuit designer may uses a set of layout EDA application programs to create a physical integrated circuit design layout from a logical circuit design. The layout EDA application uses geometric shapes of different materials to create the various electrical components on an integrated circuit and to represent electronic and circuit IC components as geometric objects with varying shapes and sizes.

After an integrated circuit designer has created an initial integrated circuit layout, the integrated circuit designer then tests and optimizes the integrated circuit layout using a set of EDA testing and analysis tools. Common testing and optimization steps include extraction, verification, and compaction. The steps of extraction and verification are performed to ensure that the integrated circuit layout will perform as desired. Extraction is the process of analyzing the geometric layout and material composition of an integrated circuit layout in order to “extract” the electrical characteristics of the designed integrated circuit layout. The step of verification uses the extracted electrical characteristics to analyze the circuit design using circuit analysis tools. Compaction is an example of a tool used to modify a layout in order to make it more suitable for manufacturing.

Common electrical characteristics that are extracted from an integrated circuit layout include capacitance and resistance of the various “nets” (electrical interconnects) in the integrated circuit. These electrical characteristics are sometimes referred to as “parasitic” since these are electrical characteristics are not intended by the designer but result from the underlying physics of the integrated circuit design. For example, when an integrated circuit designer wishes to connect two different locations of an integrated circuit with an electrical conductor, the electrical circuit designer would ideally like perfect conductor with zero resistance and zero capacitance. However, the geometry of a real conductor, its material composition, and its interaction with other nearby circuit elements will create some parasitic resistance and parasitic capacitance. The parasitic resistance and parasitic capacitance affect the operation of the designed integrated circuit. Thus, the effect of the parasitic resistance and parasitic capacitance on the electrical interconnect must be considered.

To test an integrated circuit layout, the integrated circuit designer ‘extracts’ parasitic resistance and parasitic capacitance from the integrated circuit layout using an extraction application program. Then, the integrated circuit designer analyzes and possibly simulates the integrated circuit using the extracted parasitic resistance and parasitic capacitance information. If the parasitic resistance or parasitic capacitance causes undesired operation of the integrated circuit, then the layout of the integrated circuit must be changed to correct the undesired operation. Furthermore, minimizing the amount of parasitic resistance and parasitic capacitance can optimize the performance of the integrated circuit by reducing power consumption or increasing the operating speed of the integrated circuit.

One problem with conventional EDA tools that perform extraction is that they do not adequately address lithographic effects that may occur during fabrication of the IC product. In particularly, conventional EDA tools that perform extraction cannot adequately address the deviations that exist between the intended and regular-featured geometric shapes that are designed for the IC product and the non-regular-featured geometric that actually result from lithographic processes.

This problem is further exacerbated by modem circuit design and manufacturing processes, in which surface area on an IC chip has become one of the most critical design factors. As designers and manufactures are forced to squeeze more and more circuitry onto less and less space, spacing of components on the circuits has reduced significantly. As component spacing is reduced, interactions between components is increased and in particular, the geometry of individual components can be impacted by the component's neighboring components, thus impacting electrical parameters. Levels of imperfections and error percentages that were insignificant and acceptable in older designs with the larger feature sizes and spacing have now become problematic and much more significant for modern designs having much smaller feature sizes and smaller spacing. Modern design and analysis systems and tools cannot accurately account for such geometric impacts. Therefore, what is needed is a method and system for increased accuracy for extraction of electrical parameters.

Some embodiments of the invention are directed to a method, system, and computer program product for increased accuracy for extraction of electrical parameters of an IC design. Extraction is performed upon a model of the printed layout once manufacturing and lithographic process effects are taken into consideration. This provides a much more accurate approach for performing extraction since it is the actual expected geometric shapes that are analyzed, rather than an idealized model of the layout that does not accurately correspond to the actual manufactured IC product. The extracted electrical parameters are checked for acceptability. If not acceptable, then the IC design can be modified to address any identified problems or desired improvements to the design.

### BRIEF DESCRIPTION OF THE DRAWINGS

FIG. 1 depicts theoretical geometry for two adjacent components.

FIG. 2 depicts actual geometry for two adjacent components.

FIG. 3 depicts a flow diagram of a method for increased accuracy for extraction of electrical parameters.

FIG. 4 depicts an example computerized system on which a method for increased accuracy for extraction of electrical parameters can be implemented.

### DETAILED DESCRIPTION

Some embodiments of the invention are directed to a method, system, and computer program product for increased accuracy for extraction of electrical parameters of an IC design. Instead of performing extraction upon the theoretical model of the layout geometries, extraction is performed upon the expected printed geometries of the printed layout. This provides a much more accurate approach for performing extraction since it is the actual expected geometric shapes that are analyzed, rather than an idealized model of the layout that does not accurately correspond to the actual manufactured IC product.

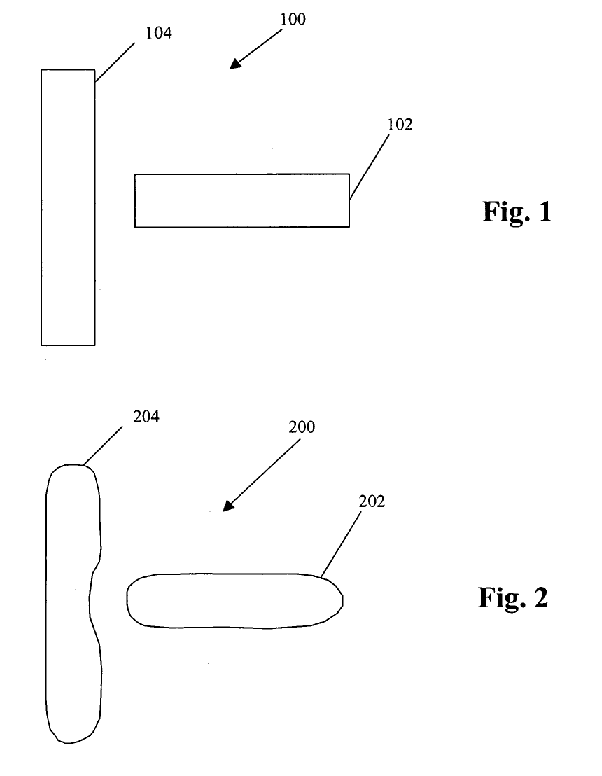

FIG. 1 depicts theoretical geometry for two adjacent components in an example IC design layout. Specifically, FIG. 1 shows two components 102 and 104 that are substantially orthogonal to each other. In this theoretical model, each of the theoretical components are shown as substantially rectangular with comers that are substantially square. This theoretical geometry is the model that would be extracted by conventional extraction tools.

FIG. 2, is a graphical representation of actual geometry that is likely to be printed for the two adjacent components 102 and 104 of FIG. 1. Specifically, FIG. 2 depicts the horizontal component 102 as having a substantially rounded end 202 and the vertical component 104 as including a notched region 204 in the area in which the components 102 104 are in close proximity.

This physical representation shows the real-world impact of neighboring components 102 and 104 on one another. Such real-world impacts can introduce significant electrical/functional errors into a design which are currently not accounted for during the design and layout process. In the present example, it can be seen that extraction errors are both possible and likely if the extraction process performs extraction upon a model represented by FIG. 1, but the printed IC device actually contained the geometries shown in FIG. 2. As noted above, this is exactly the approach taken by conventional extraction tools.

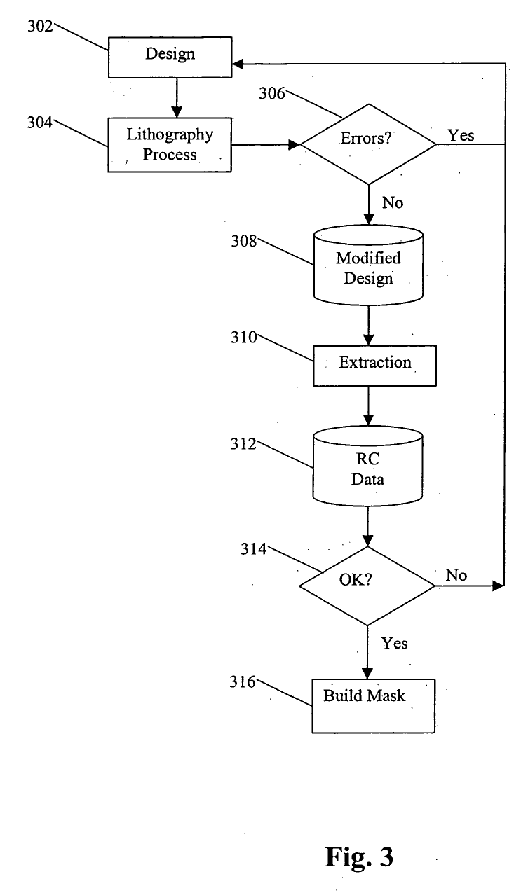

FIG. 3 depicts a flow diagram 300 of a method for increased accuracy for extraction of electrical parameters which can account for the errors introduced by the real-world impacts of proximally spaced components according to some embodiments of the invention.

In step 302, the design action can be completed using any known and/or suitable method for electrical circuitry design. Any conventional layout or place and route system/tool can be employed to perform the design action of 302. Those of ordinary skill in the art would realize that an initial verification action may occur in 302, e.g., a design rule check (DRC) to verify that the IC layout complies with mandated design rules.

In 304, analysis is performed to determine the expected imaged geometry produced as a result of the manufacturing process, possibly including OPC, mask generation, lithography, deposition and etching. Any known and/or suitable method for determining the expected imaged geometry may be employed in conjunction with the invention. For example, the RET SLiC (Silicon Lithography Checker) or Virtuoso RET products, available from Cadence Design Systems of San Jose, Calif., may be employed in conjunction with the invention to determine the expected imaged geometry of different features in the IC design. The lithographic analysis in some embodiments take into account variations and ranges of tolerance in the actual performance of the lithographic process. For example, this can account for both the situation when the lithographic process operates exactly as expected as well as when the lithographic process produces a printed image which varies by a specific range of geometric and optical variances.

The IC design and/or lithography process used to manufacture the IC product may include various enhancement or optimization techniques, such as for example, optical proximity correction (OPC) treatment, illumination, numerical aperture, nominal dose, and resist models. In some embodiments of the invention, a lithography model can include multiple ones of the above variables as parameters. In some alternative embodiments, a set of lithography models is employed, with each model specifying one parameter from the above set. In yet other embodiments, a combination of the two approaches can be employed for the lithography model(s). In other embodiments, the lithography model does not take into account any enhancement or optimization techniques such as OPC. Some examples of parameters that may be employed in a lithographic model include illuminator, wavelength, lens aperture, OPC, and resist model parameters.

A determination is made at 306 whether the printed image of the design is expected to cause an unacceptable printing error. For example, due to lithographic effects, the imaged geometries may result in erroneous configurations such as shorts, open circuits, or mis-configures shapes that do not appear in the original design. As an additional example, the printed image may include geometric values that exceed an acceptable threshold or tolerance value from the intended or acceptable design parameters even if such variances do not directly result in an open or short, e.g., excessive variance in size, dimensions, or shape. If such unacceptable errors are identified, then the process returns back to 302 to reconfigure part or all of the design. If such unacceptable errors are not identified, then the process proceeds further. In any case, the modified/determined design is stored or cached at 308 for further analysis.

In step 310, the determined design can be extracted to determine physical characteristics and layout for the proposed design. Any known and/or convenient extraction technique, method and/or system can be used to perform the extraction of the expected printed image of the design.

In some embodiments, resistance and capacitance values are extracted from the expected printed image of the design. The following are example approaches that may be employed to perform resistance and capacitance extraction in some embodiments of the invention: (a) Horowitz, M.; Dutton, R. W., Resistance Extraction from Mask Layout Data, Computer-Aided Design of Integrated Circuits and Systems, IEEE Transactions on Volume 2, Issue 3, July 1983 Page(s): 145-150; (b) K. Nabors J. White, “Multipole-accelerated 3-D capacitance extraction algorithms for structures with conformal dielectrics,” Proceedings 29th ACM/IEEE Design Automation Conference, pp. 710-715, 1992; (c) N. K. Verghese, D. Allstot, “SUBTRACT: a program for the efficient evaluation of substrate parasitics in integrated circuits,” 1995 IEEE/ACM International Conference on Computer-aided Design, pp. 194-198, 1995; (d) T. Smedes, N. P. van der Meijs, A. J. van Genderen, “Boundary Element Methods for Capacitance and Substrate Resistance Calculations in a VLSI Layout Verification Package,” Proc. ELECTROSOFT'93, pp. 337-344, July 1993; (e) Narain D. Arora, Kartik V. Roal, Reinhard Schumann, and Llanda M. Richardson, “Modeling and Extraction of Interconnect Capacitances for Multilayer VLSI Circuits”, IEEE Trans. On Computer-Aided Design of Integrated Circuits and Systems, 15(1): pp. 58-67, January 1996.

In some embodiments, inductance values are extracted. The following are example approaches that may be employed to perform inductance and resistance extraction in some embodiments of the invention: (a) M. Beattie, L. Pileggi, “IC Analyses Including Extracted Inductance Models”, Proceedings of 36th International Conference on Design Automation, pp. 915-920, June 1999; (b) J. Wang, J. Tausch, J. White, “A Wide Frequency Range Surface Integral Formulation for 3-D Inductance and Resistance Extraction,” Tech. Proc. 1999 Int. Conf. On Modeling and Simulation of Microsystems, 1999; (c) M. Kamon, N. Marques, Y. Massoud, L. Silveira, J. White, “Interconnect Analysis: From 3-D Structures to Circuit Models,” Proceedings of 36th International Conference on Design Automation, pp. 910-914, June 1999; (d) A. Ruehli, “Inductance Calculations in a Complex Integrated Circuit Environment,” IBM J. Res. Dev., vol. 16, No. 5, pp. 470-481, September 1972; (e) A. Deutsch, G. V. Kopcsay, C. W. Surovic, B. J. Rubin, L. M. Terman, R. P. Dunne, T. A. Gallo, R. H. Dennard, “Modeling and Characterization of Long On-Chip Interconnections for High-Performance Microprocessors,” IBM J. Res. Dev., vol. 39, no. 5, pp. 547-567 September 1995; (f) M. Kamon, M. J. Tsuk, and J. White, “FASTHENRY: A Multipole-Accelerated 3-D Inductance Program,” IEEE Trans on Microwave Theory and Techniques, Vol. 42, No. 9, pp. 1750-1758, September 1994; (g) Kenneth L. Shepard and Zhong Tian, “Return-Limited Inductances: A Practical Approach to On-Chip Inductance Extraction”, IEEE TRANSACTIONS ON COMPUTER AIDED DESIGN OF INTEGRATED CIRCUITS AND SYSTEMS, VOL. 19, NO. 4, APRIL 2000, pp. 425-436; (h) Michael Beattie and Lawrence Pileggi , Efficient Inductance Extraction via Windowing (2001), Proc. Design Automation & Test in Europe (DATE) (March 2001).

The values extracted at 310 may be stored at step 312. In step 312, the extraction can be verified by determination of relative and/or absolute resistance (R) and capacitance (C) values associated with the extraction. These determined resistance and capacitance values can then be compared to the selected design values. In some embodiment, the determination of resistance and capacitance values may not be performed.

In step 314, a determination is made whether the design having the electrical properties as extracted for the printed imaged is acceptable. If the design is not acceptable with those extracted characteristics/properties, then the process returns back to 302 to reconfigure part or all of the design.

One type of determination that can be made in some embodiments is to identify whether the extracted R and C values, whether individually or in combination, are acceptable. The R and C values can be checked over either absolute or relative measures to determine the acceptability of the extracted values. The R and C values, or their combination, can be checked for acceptability over a range of parameters, e.g., dose and focus, and not just at nominal values, e.g., nominal dose and focus. One approach for performing this type of determination for RC values is disclosed in U.S. patent application Ser. No. 10/327,738, filed on Dec. 23, 2002, which is hereby incorporated by reference in its entirety.

Another type of determination that can be made is to determine whether the design has acceptable timing properties. In addition to the resistance, capacitance and inductance of the net itself, the cross-coupling effects of nearby interconnect geometries may negatively affect the electrical performance of the IC device by increasing delays which cause the IC to fail timing requirements. In some embodiments of the invention, timing analysis may be performed at step 314 to verify whether the extraction data from 310/312 for the expected printed geometry would correspond to acceptable or unacceptable timing performance. If the timing performance for the design is not acceptable with those extracted characteristics/properties, then the process returns back to 302 to reconfigure part or all of the design to improve the timing performance of the unacceptable nets in the layout. In some embodiments, the user may not necessarily care about actual R and C values, and may instead only about the overall effects upon timing. Therefore, for these embodiments, the RC value for each, specific ones, or all interconnect, net, path, and/or route may not necessarily need to be extracted, stored, and/or reported.

As another example for some embodiments, lithographic rules can be applied to the proposed extraction. Lithographic rules can include predefined geometric relationships between components which are identified as either allowable relationships or disallowed relationships. Additionally, lithographic rules can related to spacing and/or any other physical relationship between two or more components. In some embodiments, the entire extraction can be evaluated for compliance with the lithographic rules. In alternate embodiments, only a selected portion of the extraction can be evaluated for compliance with the lithographic rules. In still further alternate embodiments, a portion of the extraction subject to evaluation can be determined based on any known and/or convenient factor or factors and thus can be variable. As is well known to those skilled in the art, compliance with lithographic rules can generally refer to printing acceptably over a sufficiently wide range of parameters, e.g., focus and range.

Yet another type of determination in some embodiments is to identify whether the extracted inductance (L) values are acceptable. The inductance values can be checked over either absolute or relative measures to determine the acceptability of the extracted values. The inductance values can be checked for acceptability over a range of parameters, e.g., dose and focus, and not just at nominal values, e.g., nominal dose and focus.

Step 314 can be performed to check whether the extracted electrical parameters would result in acceptable power performance for the IC layout. This type of determination can be made, for example, by analyzing the extracted capacitance values for the printed geometries and comparing the power performance against expected power specifications for design intent for the IC design. This type of analysis is particularly useful for low power designs, such as is required for many modern mobile and portable devices such ICs in cellular phones and PDAs.

It is noted that the analysis can be performed against any granularity of structures within the IC design—with the above process performed on all or just a portion of an overall IC design. In some embodiments, the analysis is performed for particular nets. In some other embodiments, the above analysis is performed over a path or route over a set of two or more nets.

If in step 314 it is determined that the IC design having the electrical properties as extracted for the printed imaged is not acceptable, then the process returns back to 302 to reconfigure part or all of the design. For example, if compliance with lithographic rule is checked in step 314, and it is determined that the IC design corresponding to the extraction data does not comply with the lithographic rules, then the process/system can return to either the design step 302 and/or the extraction step 310 and attempt to design and/or extract a system which does comply with the lithographic rules. In some embodiments, the specific regions of the IC deemed not acceptable, e.g., the portion of the extracted layout not complying with the lithographic rules, can be identified such that the design step 302 and the extraction step 310 can focus only on the identified areas.

If it is determined that the extraction complies with the lithographic rules, then a mask can be constructed in step 316. Any known and/or convenient method and/or system can be used to construct the mask in step 316. As is well known to those skilled in the art, step 316 may include the act of taping out the final IC design, e.g., in GDSII format. The taped out design is used to manufacture the mask. The mask is then used to fabricate the IC product.

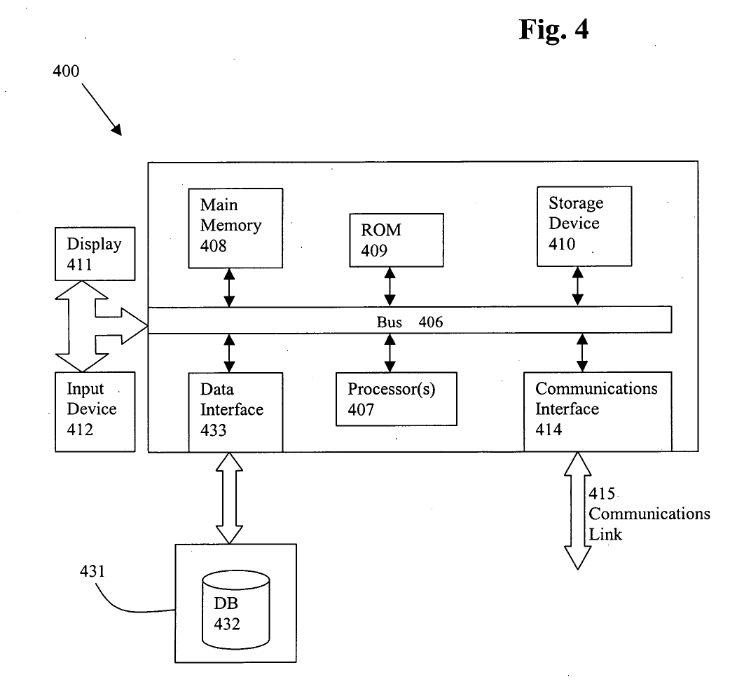

The execution of the sequences of instructions required to practice the embodiments may be performed by a computer system 400 as shown in FIG. 4. In an embodiment, execution of the sequences of instructions is performed by a single computer system 400. According to other embodiments, two or more computer systems 400 coupled by a communication link 415 may perform the sequence of instructions in coordination with one another. Although a description of only one computer system 400 will be presented below, however, it should be understood that any number of computer systems 400 may be employed to practice the embodiments.

A computer system 400 according to an embodiment will now be described with reference to FIG. 4, which is a block diagram of the functional components of a computer system 400. As used herein, the term computer system 400 is broadly used to describe any computing device that can store and independently run one or more programs.

Each computer system 400 may include a communication interface 414 coupled to the bus 406. The communication interface 414 provides two-way communication between computer systems 400. The communication interface 414 of a respective computer system 400 transmits and receives electrical, electromagnetic or optical signals, that include data streams representing various types of signal information, e.g., instructions, messages and data. A communication link 415 links one computer system 400 with another computer system 400. For example, the communication link 415 may be a LAN, in which case the communication interface 414 may be a LAN card, or the communication link 415 may be a PSTN, in which case the communication interface 414 may be an integrated services digital network (ISDN) card or a modem, or the communication link 415 may be the Internet, in which case the communication interface 414 may be a dial-up, cable or wireless modem.

A computer system 400 may transmit and receive messages, data, and instructions, including program, i.e., application, code, through its respective communication link 415 and communication interface 414. Received program code may be executed by the respective processor(s) 407 as it is received, and/or stored in the storage device 410, or other associated non-volatile media, for later execution.

In an embodiment, the computer system 400 operates in conjunction with a data storage system 431, e.g., a data storage system 431 that contains a database 432 that is readily accessible by the computer system 400. The computer system 400 communicates with the data storage system 431 through a data interface 433. A data interface 433, which is coupled to the bus 406, transmits and receives electrical, electromagnetic or optical signals, that include data streams representing various types of signal information, e.g., instructions, messages and data. In embodiments, the functions of the data interface 433 may be performed by the communication interface 414.

Computer system 400 includes a bus 406 or other communication mechanism for communicating instructions, messages and data, collectively, information, and one or more processors 407 coupled with the bus 406 for processing information. Computer system 400 also includes a main memory 408, such as a random access memory (RAM) or other dynamic storage device, coupled to the bus 406 for storing dynamic data and instructions to be executed by the processor(s) 407. The main memory 408 also may be used for storing temporary data, i.e., variables, or other intermediate information during execution of instructions by the processor(s) 407.

The computer system 400 may further include a read only memory (ROM) 409 or other static storage device coupled to the bus 406 for storing static data and instructions for the processor(s) 407. A storage device 410, such as a magnetic disk or optical disk, may also be provided and coupled to the bus 406 for storing data and instructions for the processor(s) 407.

A computer system 400 may be coupled via the bus 406 to a display device 411, such as, but not limited to, a cathode ray tube (CRT), for displaying information to a user. An input device 412, e.g., alphanumeric and other keys, is coupled to the bus 406 for communicating information and command selections to the processor(s) 407.

According to one embodiment, an individual computer system 400 performs specific operations by their respective processor(s) 407 executing one or more sequences of one or more instructions contained in the main memory 408. Such instructions may be read into the main memory 408 from another computer-usable medium, such as the ROM 409 or the storage device 410. Execution of the sequences of instructions contained in the main memory 408 causes the processor(s) 407 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 407. Such a medium may take many forms, including, but not limited to, non-volatile and volatile media. Non-volatile media, i.e., media that can retain information in the absence of power, includes the ROM 409, CD ROM, magnetic tape, and magnetic discs. Volatile media, i.e., media that can not retain information in the absence of power, includes the main memory 408.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

What is claimed is:

1. A method for performing analysis on an IC design, comprising:
(a) identifying an IC layout to analyze;
(b) estimating a set of geometries that is likely to be printed based upon analysis of a manufacturing process for the IC layout; and
(c) extracting electrical parameters from the set of geometries that is likely to be printed.

2. The method of claim 1 in which the manufacturing process is a lithography process.

3. The method of claim 2 in which the lithography process produces a printed image which varies by a specific range of geometric and optical variances.

4. The method of claim 2 in which sensitivity of the electrical parameters with respect to the geometrical and optical variances is computed.

5. The method of claim 2 in which the lithography process includes an enhancement or optimization mechanism.

6. The method of claim 5 in which the enhancement or optimization mechanism corresponds to optical proximity correction (OPC) treatment, illumination, numerical aperture, nominal dose, and/or resist models.

7. The method of claim 1 in which R and C values are extracted.

8. The method of claim 7 in which the R and C values are evaluated for suitability for correct circuit operation

9. The method of claim 7 in which the R and C values are computed by accounting for process variations.

10. The method of claim 7 in which a combination of R and C values is checked, and not just the R and C values individually

11. The method of claim 10 in which delay of the combination considered.

12. The method of claim 7 in which the R and C values are checked for acceptability over a range of parameters.

13. The method of claim 12 in which the range of parameters comprises dose and focus.

14. The method of claim 1 in which timing analysis is performed using the extracted electrical parameters to determine timing for the IC design.

15. The method of claim 1 in which inductance values are extracted.

16. The method of claim 15 in which the inductance values are checked for acceptability over a range of parameters.

17. The method of claim 1 further comprising:
(d) determining if the extracted electrical parameters are acceptable for the IC design.

18. The method of claim 17 in which the extracted electrical parameters are used to perform delay analysis.

19. The method of claim 17 in which the extracted electrical parameters are used to perform power analysis.

20. The method of claim 17 in which the extracted electrical parameters is checked of a path through the IC design and not of any particular electrical parameters values along the path.

21. The method of claim 20 in which a value measured along the path is a delay value.

22. The method of claim 17 further comprising:
(e) modifying the IC layout such that the extracted electrical parameters are more acceptable for the IC design.

23. A system for performing analysis on an IC design, comprising:
(a) means for identifying an IC layout to analyze;
(b) means for estimating a set of geometries that is likely to be printed based upon analysis of a manufacturing process for the IC layout; and
(c) means for extracting electrical parameters from the set of geometries that is likely to be printed.

24. A computer program product comprising computer usable medium having executable code, in which the executable code can be executed a process for performing analysis on an IC design, the process comprising:
(a) identifying an IC layout to analyze;
(b) estimating a set of geometries that is likely to be printed based upon analysis of a manufacturing process for the IC layout; and
(c) extracting electrical parameters from the set of geometries that is likely to be printed.
